(19) United States
(12) Patent Application Publication
(10) Pub. No.: US 2002/0139721 A1
(43) Pub. Date: Oct. 3, 2002

(54) Process for capturing mercury and arsenic in a distilled hydrocarbon cut

(76) Inventors: Blaise Didillon, Francheville (FR); Carine Petit-Clair, Montesson (FR); Laurent Savary, Rueil-Malmaison (FR)

Correspondence Address: MILLEN, WHITE, ZELANO & BRANIGAN, P.C., Arlington Courthouse Plaza I, Suite 1400, 2200 Clarendon Blvd., Arlington, VA, 22201, US

(21) Appl. No.: 09/754,321

(22) Filed: Jan. 5, 2001

(51) Int. Cl. C01G 45/00

(52) U.S. Cl. 208/253; 208/254 H; 208/251 R

(57) ABSTRACT

A process for eliminating mercury and possibly arsenic from a hydrocarbon feed comprises:

1) distilling the hydrocarbon feed to obtain at least one light cut and at least one heavy cut;

2) treating at least one said heavy cut, said treatment comprising two steps

a first step bringing said heavy cut into contact with hydrogen and a catalyst;

a second step consisting of passing the effluent from the first step over a mass for capturing mercury and possibly arsenic

The invention relates to a process for eliminating mercury and possibly arsenic from a hydrocarbon feed, comprising a step for distilling the feed and then (a) at least one two-step mercury capture stage (a catalytic decomposition step and a mercury adsorption step) carried out on at least one of the distillation cuts, and (b) at least one gas or liquid phase demercurisation step carried out on at least one of the cuts.

Liquid condensates (by-products from gas production) and certain crude oils are known to contain a variety of metallic trace compounds, usually in the form of organometallic complexes. Such metallic compounds are usually poisons for the catalysts used in processes for transforming such cuts into commercial products Mercury is particularly toxic to the activity of precious metals present and it is also highly corrosive towards aluminium parts, seals and welds.

It is thus advantageous to purify feeds for sending to processes for transforming condensates or crudes to avoid entraining mercury and possibly arsenic Purification of the feed upstream of treatment processes can protect the whole of the facility.

The Applicant has already proposed a process for eliminating mercury from hydrocarbons acting as feeds for a variety of treatment processes. The Applicant's United States patent U.S. Pat. No. 4,911,825 describes the importance of capturing mercury and possibly arsenic using a two-step process. The first step consists of bringing the feed, in the presence of hydrogen, into contact with a catalyst comprising at least one metal selected from the group formed by nickel, cobalt, iron and palladium. The mercury is not (or is only slightly) captured by the catalyst but it is activated on that catalyst so as to be captured in a second step by a mass comprising sulphur or sulphur-containing compounds.

In a further example, the Applicant's French patent application FR-A-92 14224 describes a two-step process as described above but with a step for distilling the feed after the first step The metallic mercury from the first step is then distributed into different cuts, and the light fractions are enriched and are then treated with a metallic mercury adsorption mass, as described above.

In a still further example, Japanese patent JP-103377 describes a process comprising a first feed heat treatment step carried out at a temperature of more than 200° C. to decompose all of the mercury species present in the feed to mercury metal, which is then adsorbed onto a metal sulphide.

The Applicant's United States patent U.S. Pat. No. 4 094 777 describes a process for capturing mercury in its metal form, in the gas or liquid phase using an adsorbent mass constituted by a metal sulphide.

The present invention enables the above techniques to be used in combination Instead of directly treating the feed with one or other of the methods described above, it has been discovered that by first distilling the feed to obtain a variety of cuts, the mercury (and any arsenic) is distributed differently in these cuts In general, the metallic mercury is more concentrated in the lightest cut(s), while the mercury compounds (mainly organometallic compounds) are concentrated in the heaviest cut(s) while the sludge is essentially in the heaviest cut.

Thus, the invention provides a first step for distilling the treated feed, at temperatures in the range between the initial point and the end point of the feed in question. These temperatures are in the range 20° C. to 600° C. Unlike that described in JP-103377, the aim here is not to decompose the orgyanomercuric compounds into mercury metal, but to distil into a variety of cuts, which, however, can decompose a good proportion thereof.

Thus, prior fractionation of the above feeds to be demercurised can concentrate a large proportion of the metallic mercury in the lightest cuts An increase in the mercury concentration has been observed in the light cuts after the fractionation step, the mercury being obtained by decomposition of organometallic mercury compounds or by thermal decomposition of sludges in which mercury is present A reduction in the mercury concentration has been observed in the heaviest cuts, to the benefit of the lightest cuts, which are enriched in mercury.

More precisely, a particular distribution of mercury in the distillation effluents has now been discovered. The transformation of various mercury compounds to elemental mercury by the distillation step leads to a substantial increase in the mercury concentration in the light cuts and to a reduction in the concentration of metallic mercury in the heavy cuts This change in the mercury distribution is completely unexpected since the boiling point of mercury metal is 356° C., and the mercury should be concentrated in the heavy fraction. However, distillation cannot decompose all of the species of mercury to metallic mercury, thus non-metallic mercury species remain in concentrated form in the intermediate cuts.

Further, this distillation step has the advantage of concentrating particles in suspension, known as sludge and formed from solid mineral compounds (silica .) and/or heavy hydrocarbons in the condensed form, in the heaviest portion of the distillate, in which the mercury which was present in the metallic form or organometallic form has been decomposed under the effect of temperature.

The invention thus concerns a process for eliminating mercury and possibly arsenic from a hydrocarbon feed, the process comprising.

(1) Prior distillation (or fractionation) of said hydrocarbon feed leading to a variety of cuts This distillation is carried out in a temperature range generally in the range from about 120° C. to 500° C. depending on the nature and properties of said feed

(2) Demercurisation (and possibly dearsenification) carried out on at least one of the heaviest cuts, said demercurisation being carried out in two steps

(a) a first step comprising bringing the heavy cut into contact with a catalyst in the presence of hydrogen. This step transforms the mercury organometallics to activate the mercury (or arsenic) In an advantageous example, it is possible to use the Applicant's process described in U.S. Pat. No. 4,911,825, consisting of bringing the feed into contact, in the presence of hydrogen, with a catalyst comprising at least one metal from the group constituted by nickel, cobalt, iron and palladium. The mercury is not (or is only slightly) captured by the catalyst but it is activated on this catalyst so as to be captured in the second step described below by a mass comprising, for example, sulphur or sulphur-containing compounds;

(b) a second step consisting of passing at least a portion of the effluent from the first step over a mercury capture mass comprising, for example, sulphur and/or at least one sulphur-containing compound, i.e., of passing said effluent from the first step over at least one adsorbent based, for example, on a metal sulphide deposited on a support. Advantageously, the technique described in the Applicant's patent U.S. Pat. No. 4,094,777 can be used;

(3) and optionally, adsorption of mercury contained in at least one of the lightest cuts This adsorption is carried out on an adsorbent or capture mass comprising, for example, sulphur and/or at least one sulphur-containing compound, for example another adsorbent based on a metal sulphide deposited on a support. Here again, the method described in the Applicant's patent U.S. Pat. No. 4,094,777 is used.

### EXAMPLE 4

The distilled feed was a condensate with respective mercury and arsenic contents of 500 and 200 ppb and a sludge content of 2000 ppm (containing 1% to 5% of mercury) The feed was distilled into five cuts and the mercury and arsenic distributions are shown in the two graphs below:

[image]

An accurate analysis of the mercury species present in these different cuts produced the following distribution:

| Cuts | IP-36° C. | 36-70° C. | 70-100° C. | 100-170° C. | >170° C. |
|---|---|---|---|---|---|
| Types | Hg° | Hg° | Hg° | OM* | OM* |
| of | | | | | |
| mercury | | | | | |

*: OM signifies organometallic mercury compounds

Demercurisation of these cuts thus requires installing a simple metallic mercury adsorber for the cuts containing meatllic mercury, as described in the present invention In contrast, the heaviest cuts (>100° C.), which cuts contain organometallic mercury compounds but also arsenic (see FIG. 2) will thus be decontaminated by installing a two-step purification unit, as described in the present invention.

Further, after distillation, the sludge present in the feed, also containing mercury, is found in the heaviest cut (>170° C. in the example) and is also completely demercurised.

### EXAMPLE 2

The following example used the method of Example 1 to distil a further condensate, containing only mercury but in an amount of 1500 ppb. The distribution of mercury in the different cuts is shown below:

[image]

Analysis of the mercury compounds in the different cuts showed the exclusive presence of metallic mercury Installing a simple mercury adsorber in each of these cuts produced a demercurisation efficiency of more than 99%

1. A process for eliminating mercury and possibly arsenic from a hydrocarbon feed comprising:
1) distilling the hydrocarbon feed to obtain at least one light cut and at least one heavy cut;
2) treating at least one said heavy cut, said treatment comprising two steps
a first step bringing said heavy cut into contact with hydrogen and a catalyst;
a second step consisting of passing the effluent from the first step over a mass for capturing mercury and possibly arsenic.

2. A process according to claim 1, in which in addition, at least one said light cut from the distillation step is passed over a mass for capturing mercury and possibly arsenic.

3. A process according to claim 1 or claim 2, in which for said first step, the catalyst comprises at least one metal selected from the group formed by nickel, cobalt, iron and palladium.

4. A process according to any one of claims 1 to 3, in which for said second step, the capture mass or adsorbent mass comprises sulphur and/or at least one sulphur-containing compound

5. A process according to claim 4, in which the capture mass comprises at least one metallic sulphide deposited on a support.

6. A process according to any one of claims 2 to 4, in which the capture mass over which at least one said light cut is passed comprises sulphur and/or at least one sulphur-containing compound.

7. A process according to claim 6, in which said capture mass comprises at least one metal sulphide deposited on a support

8. A process according to any one of claims 1 to 7, in which distillation is carried out between 120° C. and 500° C.
